(19) United States
(12) Patent Application Publication
(10) Pub. No.: US 2026/0141002 A1
(43) Pub. Date: May 21, 2026

(54) METHOD AND PROGRAM FOR APPROXIMATE NEAREST NEIGHBOR SEARCH VIA DATA-ADAPTIVE PARAMETER ADJUSTMENT

(71) Applicant: INDUSTRY-ACADEMIC COOPERATION FOUNDATION, YONSEI UNIVERSITY, Seoul (KR)

(72) Inventors: Sang Hyun PARK, Seoul (KR); Hui Jun JIN, Seoul (KR); Ji Eun LEE, Seoul (KR); Sheng Min PIAO, Seoul (KR); Sang Min SEO, Seoul (KR); Se In KWON, Seoul (KR)

(21) Appl. No.: 19/394,431

(22) Filed: Nov. 19, 2025

(30) Foreign Application Priority Data
Nov. 21, 2024 (KR) 10-2024-0166800

(51) Int. Cl. G06F 16/903

(52) U.S. Cl. CPC G06F 16/90335

(57) ABSTRACT

An embodiment relates to a method for constructing a graph for approximate nearest neighbor (ANN) search by dynamically adjusting parameters according to data density and dimensional characteristics. The method comprises: (a) receiving a dataset composed of a plurality of data points represented as multidimensional vectors and initial parameters; (b) calculating a density of each data point in the received dataset; (c) determining a range of parameters in consideration of variations in the densities; (d) dynamically adjusting the parameters according to the density of a specific data point based on the determined parameter range; and (e) inserting the specific data point into a graph using the adjusted parameters through a dynamic graph construction step, wherein the parameters include a ‘maximum number of connections (M_{q})’ and a ‘search depth (ef_{q})’.

### CROSS REFERENCE TO RELATED APPLICATION

The present application claims priority to Korean Patent Application No. 10-2024-0166800, filed Nov. 21, 2024, the entire contents of which are incorporated here for all purposes by this reference.

### TECHNICAL FIELD

The present invention relates to the technical field of data search and indexing, and more particularly, to a method and program for efficiently performing approximate nearest neighbor (ANN) search in high-dimensional space.

### BACKGROUND

Nearest neighbor (NN) search is an essential technology in various fields such as recommendation systems, computer vision, and natural language processing, and is important for efficiently retrieving similar items from large-scale datasets. Commonly used K-nearest neighbor (KNN) search is widely applied to quickly and accurately find neighbors close to a given data point. However, as the size and dimensionality of datasets increase, the conventional KNN method faces limitations in large-scale environments due to the high computational burden required for real-time processing.

To address this scalability issue, various approximate nearest neighbor (ANN) search algorithms have been developed, aiming to reduce computational costs while maintaining high recall performance. Among these, the hierarchical navigable small world (HNSW) algorithm has attracted attention as an effective solution for ANN search by maintaining a balance between high recall and fast search speed through a multi-layered graph structure. HNSW organizes data points into a hierarchical structure and explores neighboring nodes at each layer, and has been widely used in fields such as large-scale image retrieval, text mining, and personalized content recommendation.

However, the HNSW algorithm uses fixed parameters M (maximum number of connections per node) and ef (size of the candidate list during search, i.e., search depth) when constructing the graph. As a result, its performance can be limited when dataset density or dimensionality varies. For example, in high-density regions, larger M and ef values are advantageous to capture key neighbors, while in low-density regions, smaller values are preferable to save memory and computational resources. This fixed parameter configuration method cannot adapt to local characteristics of the data, potentially leading to missed key neighbors in high-density regions and resource inefficiency in low-density regions.

FIG. 1 illustrates a data density distribution in a two-dimensional space. In the figure, orange nodes represent high-density regions where more neighbors exist within a radius, indicating data clustering. In contrast, blue and green nodes represent medium- and low-density regions, respectively. In such low-density regions, fewer neighbors exist and the data distribution becomes sparse. These differences in density directly affect the performance of ANN search, and if parameter settings are not adjusted to match local density, efficiency can deteriorate.

This problem also occurs in other graph-based ANN search algorithms such as Navigating Spreading-out Graph (NSG), DiskANN, and EFANNA, which face limitations in adapting to various data characteristics due to globally fixed parameter settings. Some algorithms have introduced adaptive mechanisms such as learned indexes or adaptive termination strategies, but these often require complex tuning or are specialized for specific data distributions, thereby reducing generality. In this context, there is a need for a more flexible and generalized approach that can dynamically adapt to changes in data density while requiring minimal manual intervention.

### SUMMARY

The technical problem to be solved by the present invention is to provide a method and program for constructing a graph for approximate nearest neighbor (ANN) search through data-adaptive parameter adjustment, in order to overcome the aforementioned problems.

Specifically, the present invention provides a data-adaptive framework that overcomes the limitations caused by fixed parameter settings in conventional HNSW algorithms, and dynamically adjusts parameters according to the density and dimensional characteristics of the data.

To this end, the invention utilizes a random projection-based density estimation technique to calculate the local density of each data point. In high-density regions, the method increases the maximum number of neighbor connections and the search depth to improve recall performance, whereas in low-density regions, the method decreases the maximum number of connections and the search depth to reduce memory usage and computational resources.

The technical problems to be solved by the present invention are not limited to those described above, and other technical problems not mentioned herein will be clearly understood by those skilled in the art from the following description.

In order to achieve the above-described technical problem, a method for constructing a graph for approximate nearest neighbor (ANN) search by dynamically adjusting parameters according to data density and dimensional characteristics is provided, the method comprising:
(a) a receiving step of receiving a dataset composed of a plurality of data points represented as multidimensional vectors and initial parameters;
(b) a calculating step of computing a density value for each data point of the received dataset;
(c) a determining step of determining a range of the parameters by considering variations in the density;
(d) an adjusting step of dynamically adjusting the parameters according to the density of a specific data point based on the determined parameter range; and
(e) a dynamic graph construction step of inserting the specific data point into a graph using the adjusted parameters,

wherein the parameters include a ‘maximum number of connections (Ma)’ and a ‘search depth (ef_{q})’.

In an embodiment of the present invention, the step (b) may comprise projecting the dataset into a lower-dimensional space using a Random Projection (RP) method, and calculating the density of each data point in the projected low-dimensional dataset using a K-Nearest Neighbors (KNN) method. Additionally, the method may further comprise: (f) a step of setting a reference value (ef_{ref}) for the search depth by considering the number of dimensions of the dataset through the following Equation (1).

In addition, in the step (c), the variation in the density may be represented by the statistical values of the data density, namely the mean (ρ_{μ}) and standard deviation (ρ_{σ}), and the lower and upper limits of the ‘maximum number of connections (M_{q})’ may be determined through the following Equations (2) and (3), respectively, while the lower and upper limits of the ‘search depth (ef_{q})’ may be determined through the following Equations (4) and (5), respectively.

Furthermore, in the step (d), the ‘maximum number of connections (M_{q})’ may be dynamically adjusted through the following Equation (6).

In addition, in the step (d), the ‘search depth (e_{fq})’ may be dynamically adjusted through the following Equation (7).

The method may further comprise a step of repeatedly performing the steps (d) and (e) for all data points within the dataset.

Furthermore, the graph may be an HNSW (Hierarchical Navigable Small World) graph.

In order to achieve the above-described technical problem, a computer program for constructing a graph for approximate nearest neighbor (ANN) search by dynamically adjusting parameters according to data density and dimensional characteristics is provided, the program comprising instructions that, when executed by a processor, cause the processor to perform the following steps:
(a) receiving a dataset composed of a plurality of data points represented as multidimensional vectors and initial parameters;
(b) calculating a density value for each data point of the received dataset;
(c) determining a range of the parameters by considering variations in the density;
(d) dynamically adjusting the parameters according to the density of a specific data point based on the determined parameter range; and
(e) inserting the specific data point into a graph using the adjusted parameters through a dynamic graph construction step,
wherein the parameters include a ‘maximum number of connections (M_{q})’ and a ‘search depth (ef_{q})’,
and wherein the computer program is stored on a computer-readable recording medium.

In an embodiment of the present invention, the step (b) may comprise projecting the dataset into a lower-dimensional space using a Random Projection (RP) method, and calculating the density of each data point in the projected low-dimensional dataset using a K-Nearest Neighbors (KNN) method.

Additionally, the method for constructing a graph for approximate nearest neighbor (ANN) search may further comprise:
(f) a step of setting a reference value (ef_{ref}) for the search depth by considering the number of dimensions of the dataset through the following Equation (1).

Furthermore, in the step (c), the variation in density may be represented by the statistical values of the data density, namely the mean (ρ_{μ}) and standard deviation (ρ_{σ}), and the lower and upper limits of the ‘maximum number of connections (M_{q})’ may be determined through the following Equations (2) and (3), respectively, while the lower and upper limits of the ‘search depth (ef_{q})’ may be determined through the following Equations (4) and (5), respectively.

In addition, in the step (d), the ‘maximum number of connections (M_{q})’ may be dynamically adjusted through the following Equation (6).

Further, in the step (d), the ‘search depth (ef_{q})’ may be dynamically adjusted through the following Equation (7).

Moreover, the method for constructing a graph for approximate nearest neighbor (ANN) search may further comprise a step of repeatedly performing the steps (d) and (e) for all data points within the dataset.

Furthermore, the graph may be an HNSW (Hierarchical Navigable Small World) graph.

According to an embodiment of the present invention, a method and program for constructing a graph for approximate nearest neighbor (ANN) search through data-adaptive parameter adjustment can be provided.

In addition, the present invention overcomes the limitations of fixed parameter settings in conventional HNSW algorithms, thereby enabling efficient and accurate approximate nearest neighbor search.

Specifically, the present invention calculates the local density of each data point using a random projection-based density estimation technique, and based on this, increases the maximum number of connections and search depth in high-density regions to enhance recall performance. Conversely, in low-density regions, the maximum number of connections and search depth are decreased to reduce memory usage and computational resources, thereby generating an optimized graph structure that efficiently utilizes resources.

As a result, the present invention maintains high search performance and efficiency even in datasets with varying density distributions, providing fast and accurate approximate nearest neighbor search in large-scale data environments. These characteristics enhance the applicability of the invention to various fields requiring real-time processing of large-scale data, such as image retrieval, recommendation systems, and natural language processing.

The effects of the present invention are not limited to those described above, and should be understood to include all effects that can be inferred from the configurations of the invention described in the specification or the claims.

### BRIEF DESCRIPTION OF THE DRAWINGS

FIG. 1 illustrates a data density distribution in a two-dimensional space.

FIG. 2 is a flowchart illustrating a method for constructing a graph for approximate nearest neighbor (ANN) search by dynamically adjusting parameters according to data density and dimensional characteristics, according to an embodiment of the present invention.

FIG. 3 illustrates improvements in build time and memory usage for each dataset according to an embodiment of the present invention.

FIG. 4 illustrates a comparison of recall performance for each dataset according to an embodiment of the present invention.

FIG. 5 illustrates a performance comparison according to various M and ef values between an embodiment of the present invention and a comparative example.

FIG. 6 illustrates an analysis of the performance impact of the expansion coefficient and adjustment coefficient according to an embodiment of the present invention.

FIG. 7 illustrates a computing device for implementing the method for constructing a graph for approximate nearest neighbor (ANN) search according to an embodiment of the present invention.

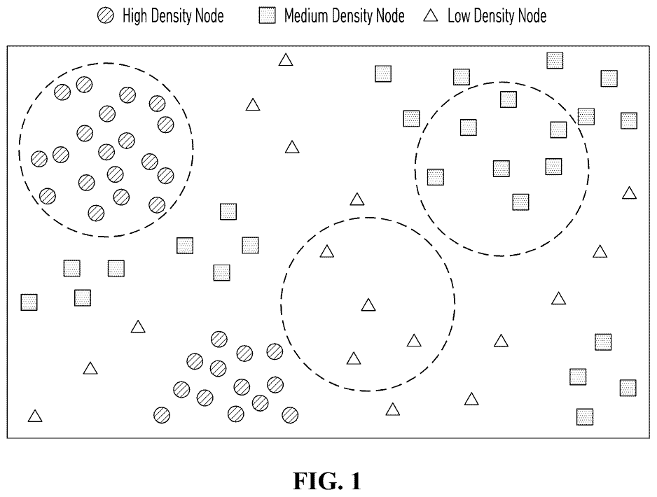

### DETAILED DESCRIPTION

Hereinafter, the present invention will be described with reference to the accompanying drawings. However, the present invention may be implemented in various different forms and is not limited to the embodiments described herein. In the drawings, parts not related to the description are omitted for clarity of explanation of the invention, and like reference numerals are used to denote like elements throughout the specification.

Throughout the specification, when a part is described as being “connected (coupled, attached, or contacted)” to another part, it includes not only a case of being “directly connected,” but also a case of being “indirectly connected” through another member interposed therebetween. In addition, when a part is described as “including” a certain component, it should be understood, unless specifically stated otherwise, that other components are not excluded and may further be included.

The terminology used in the present specification is intended only to describe specific embodiments and is not intended to limit the present invention. Singular expressions include plural forms unless the context clearly indicates otherwise. As used herein, terms such as “comprise” or “have” are intended to specify the presence of stated features, numbers, steps, operations, components, parts, or combinations thereof, but are not intended to preclude the presence or addition of one or more other features, numbers, steps, operations, components, parts, or combinations thereof.

As used herein, the term “module” includes a unit composed of hardware, software, or firmware, and may be interchangeably used with terms such as logic, logic block, component, or circuit. A module may be an integrated part or the smallest unit or a portion thereof that performs one or more functions. For example, a module may be implemented as an ASIC (application-specific integrated circuit).

Hereinafter, embodiments of the present invention will be described in detail with reference to the accompanying drawings.

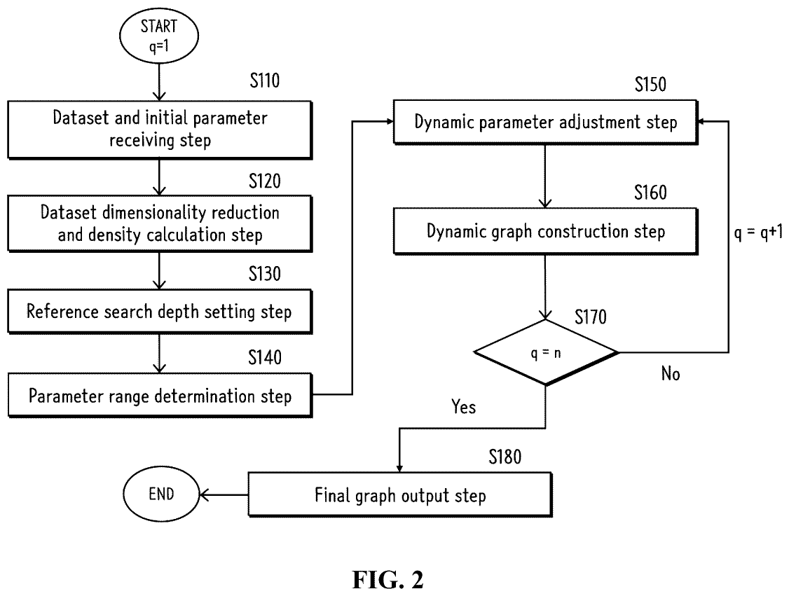

FIG. 2 is a flowchart illustrating a method for constructing a graph for approximate nearest neighbor (ANN) search by dynamically adjusting parameters according to data density and dimensional characteristics, according to an embodiment of the present invention.

The graph construction method for approximate nearest neighbor search may include a dataset and initial parameter receiving step (S110), a dimensionality reduction and density calculation step (S120), a reference search depth setting step (S130), a parameter range determining step (S140), a dynamic parameter adjustment step (S150), a dynamic graph construction step (S160), a repetition step (S170), and a final graph output step (S180).

In the dataset and initial parameter receiving step (S110), the system receives, from a user, a dataset composed of a plurality of data points represented as multidimensional vectors and initial parameters in order to construct a graph for approximate nearest neighbor search.

For example, when performing a search using image feature vectors, each data point may be composed of a vector representing features of an image.

As one example, the dataset D may be input in the form of {x₁, x₂, . . . , xₙ}, where xᵢ represents each data point, and n denotes the number of data points included in the dataset.

In addition, the user may set an initial maximum number of connections (Mᵢₙᵢₜ) and an initial search depth (efᵢₙᵢₜ) as initial parameters.

The initial maximum number of connections (Mᵢₙᵢₜ) refers to the maximum number of connections that each node can have, and determines the maximum number of neighboring nodes that a data point can be connected to within the graph. According to an embodiment of the present invention, if the user does not set the value of Mᵢₙᵢₜ, the system may use a default value of 16.

The initial search depth (efᵢₙᵢₜ) represents the size of the candidate list to be maintained during the search and serves to control the search depth. It affects search accuracy and computational efficiency by controlling the number of candidate groups considered in the ANN search. According to an embodiment of the present invention, if the user does not set the value of efᵢₙᵢₜ, the system may use a default value of 100.

The dimensionality reduction and density calculation step (S120) is a step in which the system reduces the dimensions of the received dataset and calculates the density of each data point.

In high-dimensional datasets, calculating the density of data points generally consumes significant computational resources, and as the dimensionality increases, the distance between data points becomes large, resulting in the so-called ‘curse of dimensionality’, which makes density calculation difficult.

To address this problem, in step (S120), the system may perform dimensionality reduction and density calculation using an RP-KNN (Random Projection-K-Nearest Neighbors) method.

An example of the dimensionality reduction and density calculation process according to the RP-KNN method is described below.

First, each data point xᵢ of the dataset D={x₁, x₂, . . . , xₙ} may be projected into a lower-dimensional space through random projection. This random projection is based on the Johnson-Lindenstrauss lemma and is a method for reducing dimensionality while maintaining, with high probability, the relative distances between two data points in the high-dimensional space.

Subsequently, in the low-dimensional projected dataset, a KNN search may be performed for each data point to identify K neighboring points around a specific data point xᵢ. Through this process, the degree of clustering of each data point with its neighboring data points can be determined, and based on this information, the density can be calculated. For example, if the average distance to the K-nearest neighbors of xᵢ is short, the data point may be determined to be located in a high-density region, whereas if the average distance is long, the data point may be determined to be located in a low-density region.

Accordingly, the density information ρ={ρ₁, ρ₂, . . . , ρₙ} of each data point may be calculated based on the distances to its neighboring data points, thereby reducing the computational complexity of density estimation while maintaining high accuracy for high-dimensional datasets.

The reference search depth setting step (S130) is a step of setting a reference value for the search depth by considering the number of dimensions of the dataset.

As the dimensionality of the dataset increases, the distances between data points become less distinguishable, leading to the so-called ‘curse of dimensionality’, which makes effective searching difficult. To address this issue, it is necessary to adjust the search depth so that the distances between data points can be efficiently computed.

Accordingly, in step (S130), the reference search depth (ef_{ref}) is calculated and set based on the dimensionality of the dataset, and the reference search depth (ef_{ref}) may be calculated through the following Equation (1).

$${ef}_{ref} = ⌊ {ef}_{init} + {( \frac{dim ( D )}{α} )}^{2} ⌋ \qquad [ Equation 1 ]$$

Here, efᵢₙᵢₜ denotes the initial search depth, and dim (D) denotes the number of dimensions of the dataset. The parameter α represents an adjustment parameter. The adjustment parameter serves to control the magnitude of the search depth adjustment and to regulate the rate of increase in search depth according to the data dimensionality. The symbol └ ┘ represents the operation of rounding down to the nearest integer, which is used because parameters in the algorithm must be processed as integers.

The parameter range determination step (S140) is a step in which the system determines the range of each parameter by considering the density variation of the dataset.

First, the density variation may be represented using statistical values of data density, namely the mean (ρ_{μ}) and the standard deviation (ρ_{σ}). By utilizing these statistical values to set parameters suitable for the density characteristics of each data point, the system can flexibly adapt to the density characteristics of the dataset.

First, the range of M_{q}, that is, the lower and upper limits, may be set through the following Equations (2) and (3), respectively.

$${M}_{low} = max ( 2 , ⌊ {M}_{init} - {M}_{init} \times \frac{{ρ}_{σ}}{{ρ}_{μ}} \times λ ⌋ ) \qquad [ Equation 2 ]$$

$${M}_{high} = ⌊ {M}_{init} + {M}_{init} \times \frac{{ρ}_{σ}}{{ρ}_{μ}} \times λ ⌋ \qquad [ Equation 3 ]$$

Here, Mᵢₙᵢₜ denotes the initial maximum number of connections set by the user, ρ_{σ} represents the standard deviation of the dataset density, Pu represents the mean of the dataset density,

$$\frac{{ρ}_{σ}}{{ρ}_{μ}}$$

is a coefficient or variation indicating the degree of density variation within the dataset, and λ is an expansion coefficient that controls the sensitivity of parameter adjustment according to density variation.

The coefficient of variation configured in this manner allows the system to consider the degree of density variation in different regions of the dataset so that the maximum number of connections can be proportionally adjusted according to the data density. In addition, the expansion coefficient λ controls the sensitivity of parameter adjustment to density changes, enabling a higher number of neighbor connections in high-density regions to improve search accuracy, while preventing under-connection in low-density regions.

The range of the search depth (ef_{q}), that is, the lower and upper limits, may be set through the following Equations (4) and (5), respectively.

$${ef}_{low} = max ( 10 , ⌊ {ef}_{ref} - {ef}_{ref} \times \frac{{ρ}_{σ}}{{ρ}_{μ}} \times λ ⌋ ) \qquad [ Equation 4 ]$$

$${ef}_{high} = ⌊ {ef}_{ref} + {ef}_{ref} \times \frac{{ρ}_{σ}}{{ρ}_{μ}} \times λ ⌋ \qquad [ Equation 5 ]$$

Here, ef_{ref} represents the reference search depth.

By setting the lower limit of ef_{q}, sufficient candidate searches can be ensured even for sparse nodes, thereby maintaining recall performance. In addition, by setting the upper limit of ef_{q}, deeper searches can be performed for high-density nodes, allowing more accurate nearest neighbors to be found.

Similarly, the coefficient of variation reflects the degree of density variation among different regions of the dataset so that the search depth can be proportionally adjusted according to data density, while the expansion coefficient (λ) controls the sensitivity of parameter adjustment to local density variation. For example, in a dataset with large density variation, a higher λ value may be used to emphasize the parameter differences between high-density and low-density regions, whereas in a dataset with small density variation, a lower λ value may be used to maintain an overall uniform parameter configuration.

The ranges of M_{q} and ef_{q} configured in this manner may be dynamically adjusted according to the density characteristics of the dataset.

In the dynamic parameter adjustment step (S150), the system may dynamically adjust parameters according to the density of each data point based on the determined parameter ranges.

For example, the maximum number of connections M_{q} may be dynamically adjusted through the following Equation (6). In this approach, as the density x_{q} of a data point ρ_{q} increases, the value of M_{q} is set higher so that sufficient connections can be secured in high-density regions.

$${M}_{q} = ⌊ {M}_{l o w} + ( \frac{{ρ}_{q} - {ρ}_{m i n}}{{ρ}_{ma x} - {ρ}_{m i n}} ) \times ( {M}_{h i g h} - {M}_{l o w} ) ⌋ \qquad [ Equation 6 ]$$

Here, M_{low} represents the lower limit of M_{q}, M_{high} represents the upper limit of M_{q}, ρₘᵢₙ represents the minimum value of data density, and ρₘₐₓ represents the maximum value of data density.

The search depth ef_{q} may be dynamically adjusted through the following Equation (7). In high-density regions, the value of ef_{q} may be increased to perform deeper searches, whereas in low-density regions, the value of ef_{q} may be decreased to save computational resources.

$$e {f}_{q} = ⌊ {ef}_{l o w} + ( \frac{{ρ}_{q} - {ρ}_{m i n}}{{ρ}_{m ax} - {ρ}_{m i n}} ) \times ( e {f}_{h i g h} - e {f}_{l o w} ) ⌋ \qquad [ Equation 7 ]$$

Here, ef_{low} represents the lower limit of ef_{q}, ef_{high} represents the upper limit of ef_{q}, ρₘᵢₙ represents the minimum value of data density, and ρₘₐₓ represents the maximum value of data density.

According to an embodiment of the present invention, the dynamically set M_{q} and ef_{q} for each data point apply parameters optimized for local density characteristics, thereby providing the effect of ensuring high recall performance in high-density regions and reducing resource consumption in low-density regions.

In the dynamic graph construction step (S160), each data point x_{q} may be inserted into the graph using the dynamically calculated parameters M_{q} and ef_{q}. In this step, each data point may be connected to optimal neighboring nodes according to the dynamically adjusted maximum number of connections and search depth.

By constructing a graph reflecting such dynamic parameters, sufficient connectivity and deeper search capability can be provided in high-density regions, while memory and computational resources can be efficiently conserved in low-density regions.

In the repetition step (S170), the dynamic parameter adjustment step (S150) and the dynamic graph construction step (S160) may be repeatedly performed for all data points within the dataset D.

That is, for each data point x_{q}, the optimal parameter configuration corresponding to its density is calculated, and based on this configuration, the data point is inserted into the graph. By repeating this process for all data points in the dataset, the entire graph can be configured to adapt to the density characteristics of the data.

Through such repetition, all data points within the dataset can be connected and searched according to their respective local characteristics, thereby achieving efficient approximate nearest neighbor (ANN) search performance even in large-scale, high-dimensional datasets.

In the final graph output step (S180), since all data points are connected to the graph according to the optimal parameters M_{q} and ef_{q}, a graph structure optimized for the density characteristics of the data can be formed.

The finally generated graph has a structure in which the connectivity is dynamically adjusted according to the density of each point in the dataset. In high-density regions, fast and accurate searches between points can be performed through a high maximum number of connections and a high search depth, while in low-density regions, unnecessary connections are reduced and the graph is configured with a shallow search depth to save memory and computational resources.

Due to these structural characteristics, the final graph can provide consistent search performance and efficiency even for datasets with various density distributions. The completed HNSW graph may be stored as a file or loaded into memory for subsequent search operations. For example, the graph may be stored on disk and retrieved when necessary, or it may reside in a memory cache for real-time search operations.

The graph may be utilized to efficiently find neighbors similar to an input data point in approximate nearest neighbor (ANN) search tasks. For example, in a large-scale image retrieval system, a user may upload an image to quickly perform a search for similar images. The final HNSW graph can be used to recommend the most similar neighbors based on the feature vector of the uploaded image during such image similarity searches. In addition, the final graph may be employed in various fields such as text mining, recommendation systems, and natural language processing (NLP) to perform real-time searches and recommendations of similar items.

### Embodiment: Verification and Performance Evaluation

Verification according to an embodiment of the present invention was performed to compare and evaluate the performance of the DHNSW (Dynamic Hierarchical Navigable Small World) algorithm with that of the conventional HNSW algorithm. The experiments focused on three primary metrics—build time, memory usage, and recall—to verify how much performance improvement could be achieved through dynamic parameter adjustment compared to static parameter settings.

In addition, four datasets with different characteristics were used for performance evaluation. Each dataset has distinct density distributions and dimensionalities, making them suitable for evaluating the DHNSW algorithm across a wide range of conditions. The datasets used are as follows:

MNIST: A handwritten image dataset exhibiting relatively uniform density in a low-dimensional space, suitable for evaluating performance in low dimensions.

GloVe100K: A text embedding dataset appropriate for evaluating density distribution in medium-dimensional spaces.

SIFTIM: An image feature vector dataset representing complex density distributions in high-dimensional space, suitable for evaluating performance in high-dimensional environments.

GISTIM: A high-dimensional image dataset suitable for assessing performance under complex high-dimensional distributions.

Detailed information for each dataset is summarized in [Table 1] below. Through these datasets reflecting various density distributions and dimensional characteristics, the DHNSW algorithm can be comprehensively evaluated in terms of how it responds to changes in data density and dimensionality.

TABLE 1

| Dataset | Dimensions | Size | | Number of Data Points |
|---|---|---|---|---|
| MNIST | 784 | 52 | MB | 60,000 |
| GloVe100K | 300 | 990 | MB | 100,000 |
| SIFT1M | 128 | 550 | MB | 1,000,000 |
| GIST1M | 960 | 5.37 | GB | 1,000,000 |

The performance evaluation metrics used in the embodiment of the present invention consist of three indicators: build time, memory usage, and recall.

Build time refers to the total time required to construct the HNSW graph for each dataset. In particular, for large-scale datasets, reducing build time is an important factor in real-time applications. A reduction in the build time of the DHNSW algorithm indicates improved computational efficiency and enables rapid graph construction even in large-scale environments.

Memory usage represents the maximum memory consumption occurring during the graph construction process and serves as an indicator of how efficiently the algorithm manages memory resources. The DHNSW algorithm reduces memory usage to ensure stable operation even in limited-memory environments, thereby improving deployability across various computing environments. In particular, memory reduction is highly advantageous for devices with constrained memory capacity.

Recall indicates how accurately the algorithm identifies the true nearest neighbors and serves as a metric for evaluating search accuracy. This metric reflects how many relevant neighbors the algorithm captures in the top-k results and demonstrates that the DHNSW algorithm is designed to maintain high search quality even in high-density regions. A high recall value indicates high search accuracy, which is a critical performance indicator in applications such as recommendation systems and large-scale data analysis.

The purpose of this verification is to evaluate how the dynamic parameter adjustment mechanism of the DHNSW algorithm improves upon the limitations of the static parameter configuration used in conventional HNSW. The DHNSW algorithm is designed to flexibly scale across datasets with varying densities and dimensions, thereby demonstrating improved performance in terms of build time, memory usage, and recall proving its effectiveness as an efficient ANN search solution suitable for real-time applications.

By dynamically adjusting parameters according to changes in data density and dimensionality, the DHNSW algorithm provides advantages in optimizing both search speed and resource efficiency. This makes it particularly useful in a wide range of applications such as real-time recommendation systems, text mining, and large-scale image retrieval.

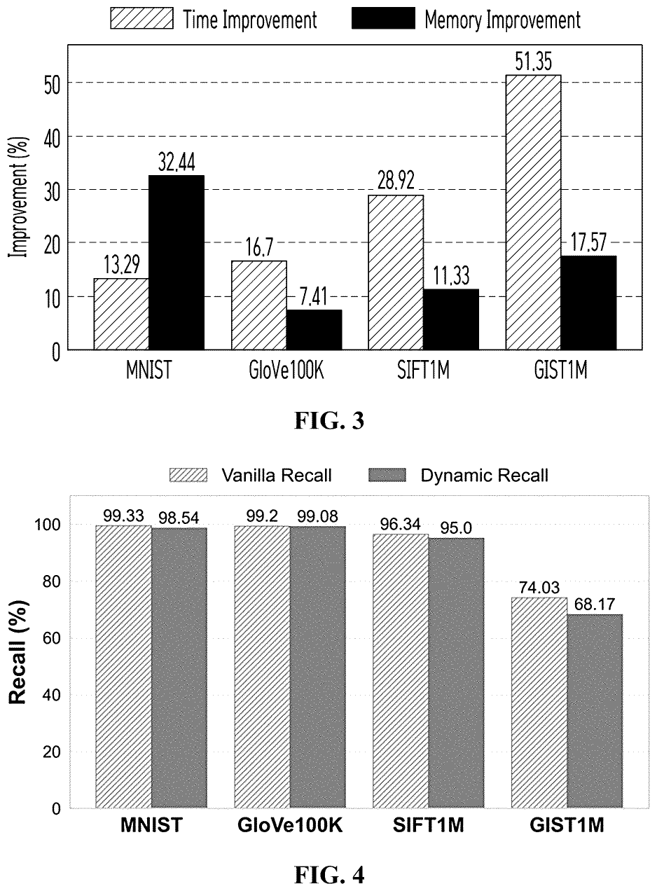

FIG. 3 illustrates the improvement rates of build time and memory usage for each dataset according to an embodiment of the present invention, and FIG. 4 illustrates a comparison of recall performance for each dataset according to the embodiment of the present invention.

The performance verification of the embodiment of the present invention was conducted by comparing the proposed DHNSW (Dynamic Hierarchical Navigable Small World) algorithm (i.e., the embodiment of the present invention) with the conventional HNSW algorithm (i.e., vanilla HNSW, comparative example) across four benchmark datasets. The initial settings were M=16, ef=100, α=100, and λ (lambda), and the results are summarized in FIGS. 3 and 4.

In the graph construction process, the embodiment of the present invention demonstrated a significant reduction in build time. In particular, as the dataset size and dimensionality increased, the embodiment of the present invention exhibited substantially improved performance compared to the comparative example by flexibly responding to density and dimensional variations through dynamic parameter adjustment, minimizing redundant computations, and optimizing the graph generation process.

As shown in FIG. 3, the embodiment of the present invention exhibited a particularly significant improvement in build time for large-scale, high-dimensional datasets such as SIFT1M and GIST1M. For example, in the GIST1M dataset, a 51.35% reduction in build time was achieved, demonstrating the scalability and efficiency of the DHNSW algorithm. This performance improvement may result from performing deeper searches in high-density regions while reducing unnecessary computations in low-density regions.

In addition, the embodiment of the present invention efficiently managed memory usage, showing an advantage in reducing memory consumption compared to the vanilla HNSW (comparative example). This effect is particularly beneficial for datasets with diverse density distributions, as it prevents unnecessary memory allocation and conserves memory resources. As shown in FIG. 3, the embodiment of the present invention reduced memory usage across all datasets, with the reduction rate varying from 7.41% to 32.44% depending on the size and complexity of the dataset. For example, in the MNIST dataset, memory usage decreased by 32.44%, and in the high-dimensional GIST1M dataset, a memory reduction of 17.57% was also observed. Such memory-saving effects enhance the applicability of the DHNSW algorithm in resource-constrained environments and make it suitable for large-scale systems.

In terms of recall performance, the embodiment of the present invention maintained a level comparable to that of the vanilla HNSW (comparative example) across most datasets, although a slight decrease was observed. This decrease can be regarded as a trade-off resulting from the design emphasis on resource efficiency in the DHNSW algorithm, and it remains within an acceptable range considering the performance improvements in build time and memory usage. As shown in FIG. 4, the embodiment of the present invention maintained recall values above 95% for the MNIST, GloVe100K, and SIFT1M datasets, confirming that it can provide sufficiently high search accuracy for most real-world applications.

In contrast, for the high-dimensional dataset GIST1M, the recall value decreased slightly from 74.03% in the comparative example (HNSW) to 68.17% in the embodiment of the present invention (DHNSW). However, this reduction is acceptable in environments such as large-scale data indexing and real-time recommendation systems, where computational efficiency is prioritized. In such cases, the advantages of reduced build time and memory usage offered by DHNSW become more critical.

Overall, the embodiment of the present invention demonstrates that DHNSW is a scalable solution adaptable to datasets with diverse density distributions and dimensional characteristics. In particular, in real-time application environments where memory efficiency and reduced build time are crucial, DHNSW provides effective performance. By dynamically adjusting optimally tuned parameters according to the characteristics of the dataset, DHNSW can be evaluated as a powerful algorithm capable of maximizing search efficiency.

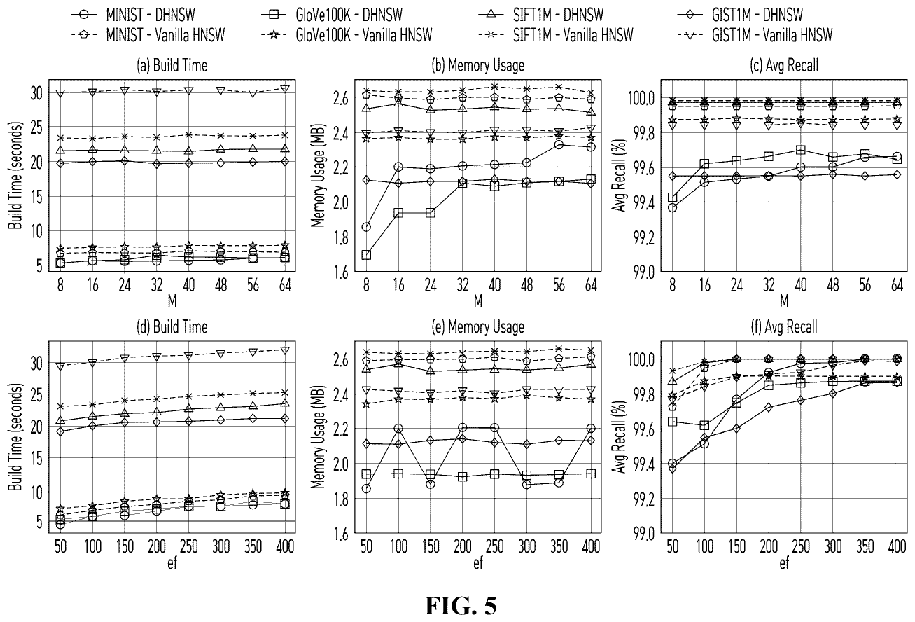

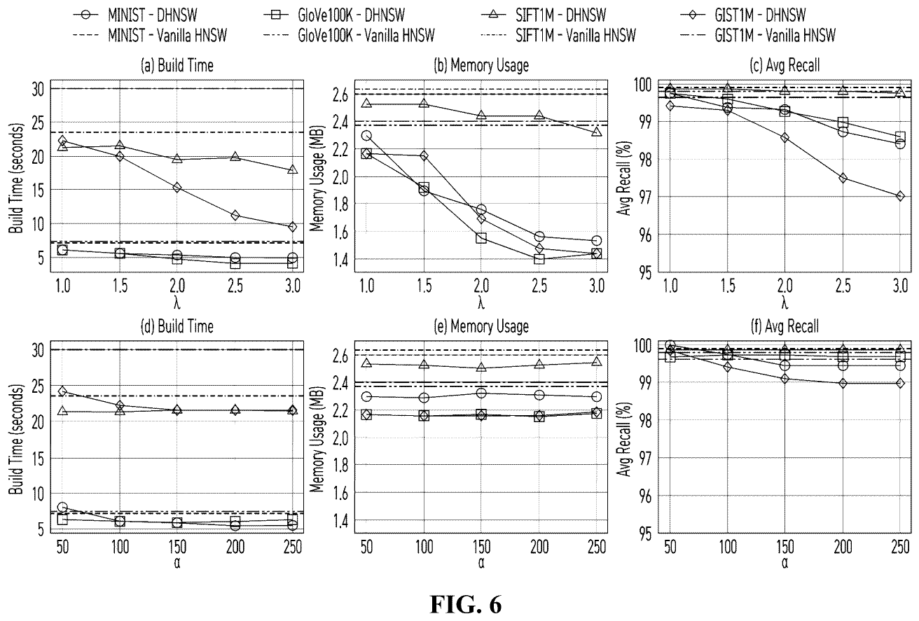

FIG. 5 illustrates the performance comparison between the DHNSW (Dynamic Hierarchical Navigable Small World) algorithm according to an embodiment of the present invention and the conventional HNSW (vanilla HNSW, comparative example) under various initial parameter settings of M and ef, while FIG. 6 shows the analysis results of the performance impact of the expansion coefficient (λ) and adjustment coefficient (α) of DHNSW. This experiment was conducted to evaluate the robustness of the DHNSW algorithm under different initial parameter configurations and to assess the influence of major hyperparameters on its performance.

A representative subset of 1,000 data points from each dataset was used to reduce experimental costs while preserving the essential characteristics of each dataset. The evaluation was systematically performed by varying two key parameters, M and ef, to compare the performance of DHNSW and vanilla HNSW. M was increased from 8 to 64 in increments of 8, and ef was increased from 50 to 400 in increments of 50 to analyze performance variations of DHNSW across different parameter configurations.

As shown in FIGS. 5(a) and 5(d), the DHNSW algorithm consistently achieved shorter build times than the vanilla HNSW across all datasets. In particular, for high-dimensional datasets such as GIST1M, the build time of DHNSW was reduced by approximately 33%, demonstrating its ability to effectively adapt to variations in data density and dimensionality.

As can be seen in FIGS. 5(b) and 5(e), DHNSW also used less memory than the vanilla HNSW under all parameter configurations. For datasets with diverse density distributions, DHNSW dynamically adjusted memory resources according to local data density, reducing memory usage by as much as 30-35%. This memory reduction demonstrates that DHNSW can manage resources efficiently without compromising performance.

The recall results shown in FIGS. 5(c) and 5(f) indicate that DHNSW maintained a recall level comparable to that of the vanilla HNSW in most cases. Although slight recall fluctuations occurred with different parameter settings, the difference in recall between DHNSW and vanilla HNSW was less than 1% in the majority of cases. This demonstrates that the dynamic adjustment mechanism of DHNSW is effective in maintaining search accuracy and that similar recall performance can be achieved even with lower values of M and ef, proving that the dynamic adjustment has little impact on search accuracy.

Meanwhile, the effects of two main hyperparameters that control the performance of DHNSW, the expansion coefficient (λ) and the adjustment coefficient (α), were analyzed. The expansion coefficient λ controls the sensitivity of parameter adjustment according to data density, while the adjustment coefficient α controls the sensitivity of parameter adjustment according to dimensional changes. These two hyperparameters enable DHNSW to adapt to various dataset characteristics. The experiment was conducted under the basic parameter settings of M=16 and ef=100, and the results are shown in FIG. 6.

As shown in FIGS. 6(a) and 6(b), the expansion coefficient λ had a significant impact on the build time and memory usage of DHNSW. Increasing the A value allowed the algorithm to adjust parameters more flexibly, leading to noticeable performance improvements in high-dimensional datasets. For example, in the GIST1M dataset, increasing the λ value significantly reduced both build time and memory usage, demonstrating that DHNSW effectively responds to the processing demands of high-dimensional data. As shown in FIG. 6(c), the recall performance slightly decreased; however, the reduction was considered acceptable compared to the substantial improvements in build time and memory efficiency.

As shown in FIGS. 6(d), 6(e), and 6(f), the adjustment coefficient α exhibited a relatively stable influence on build time and memory usage. Although no significant performance differences were observed with changes in the a value across most datasets, when a was set to 50, some datasets showed slightly improved recall performance compared to the vanilla HNSW. This suggests that dynamic adaptation can fine-tune search performance for specific data distributions and achieve higher recall under certain configurations.

The results presented in FIGS. 5 and 6 demonstrate that DHNSW provides consistent performance improvements over the vanilla HNSW across various parameter and hyperparameter settings, thereby proving the robustness of its dynamic adjustment to density variations. In particular, the expansion coefficient λ plays a key role in significantly reducing memory usage and build time in high-dimensional datasets, while the adjustment coefficient α enables fine-tuning of recall performance.

Accordingly, the present invention can provide a method and program for constructing a graph for approximate nearest neighbor (ANN) search through data-adaptive parameter adjustment.

In addition, the present invention overcomes the limitations of fixed parameter settings in conventional HNSW algorithms, thereby enabling efficient and accurate approximate nearest neighbor search.

Specifically, the present invention calculates the local density of each data point using a random projection-based density estimation technique, and based on this, increases the maximum number of connections and search depth in high-density regions to improve recall performance. In contrast, in low-density regions, the maximum number of connections and search depth are decreased to reduce memory usage and computational resources, thereby generating an optimized graph structure that efficiently utilizes system resources.

As a result, the present invention maintains high search performance and efficiency even in datasets with varying density distributions, providing fast and accurate approximate nearest neighbor search in large-scale data environments. These characteristics enhance the applicability of the invention to various fields requiring real-time processing of large-scale data, such as image retrieval, recommendation systems, and natural language processing.

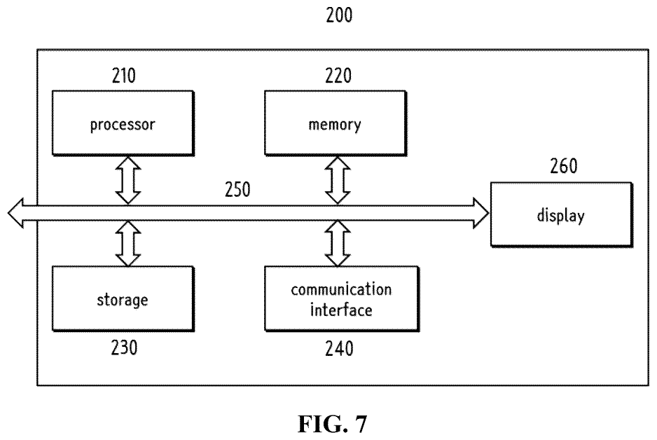

FIG. 7 illustrates a computing device for implementing a graph construction method for approximate nearest neighbor (ANN) search according to an embodiment of the present invention.

The embodiment of the present invention described with reference to FIG. 2 may be implemented by a computing device (200) operated by at least one processor.

The computing device (200) may include a processor (210), a memory (220), a storage (230), a communication interface (240), a system interconnect (250), and a display (260).

The processor (210) may include a Central Processing Unit (CPU), a Micro Processor Unit (MPU), a Micro Controller Unit (MCU), a Graphic Processing Unit (GPU), and an Application Processing Unit (APU).

The memory (220) interacts with the processor (210) to store data and enable efficient program execution and rapid access to required information. The memory (220) may include at least one of a register, cache memory, main memory, read-only memory, virtual memory, or non-volatile memory.

The storage (230) serves to permanently store and manage data. The storage preserves data even when the computing system is powered off or rebooted, and is used to store the operating system, applications, and user files. The storage (230) may include at least one of a hard disk drive (HDD), solid-state drive (SSD), optical disk, network storage, or cloud storage.

The communication interface (240) provides a pathway for transmitting and receiving data between various internal and external devices of the computing system. The communication interface (240) may support at least one communication method selected from USB (Universal Serial Bus), PCIe (Peripheral Component Interconnect Express), SATA (Serial ATA), Ethernet, Wi-Fi, Thunderbolt, and HDMI (High-Definition Multimedia Interface).

The system interconnect (250) transmits and exchanges data and signals between various components within the computing system. The system interconnect (250) may support at least one of a bus, point-to-point connection, crossbar switch, or network-on-chip (NoC) configuration.

The display (260) functions as an output device of the computing system and provides visual information to the user.

According to the foregoing configuration, the program according to an embodiment of the present invention is executed based on instructions run by the processor (210) and may be stored in the memory (220) or the storage (230).

The method according to the embodiment of the present invention described above may be implemented in the form of program instructions that can be executed through various computer components and may be recorded on a computer-readable recording medium. The computer-readable recording medium may include program instructions, data files, and data structures either alone or in combination. The program instructions recorded on the computer-readable recording medium may be specially designed and configured for the embodiments of the present invention or may be those known and available to those skilled in the field of computer software.

The computer-readable recording medium includes hardware configured to store and execute program instructions, such as magnetic recording media including hard disks, floppy disks, and magnetic tapes; optical recording media including CD-ROMs and DVDs; magneto-optical media such as floptical disks; and semiconductor memories such as ROM, RAM, and flash memory.

The program instructions include machine code generated by a compiler and high-level language code that can be executed by a computer using an interpreter. The hardware may be configured to operate as one or more software modules to process the method according to the present invention, and vice versa.

The method according to an embodiment of the present invention may be executed in the form of program instructions in an electronic device. The electronic device may include portable communication devices such as smartphones or smartpads, computer devices, portable multimedia devices, portable medical devices, cameras, wearable devices, and home appliances.

The method according to an embodiment of the present invention may be provided as part of a computer program product. The computer program product may be traded as a commodity between sellers and purchasers. The computer program product may be distributed in the form of a machine-readable recording medium or online through an application store. In the case of online distribution, at least a part of the computer program product may be temporarily stored or generated in a storage medium such as a manufacturer's server, an application store server, or a relay server memory.

Each component, such as a module or program, according to an embodiment of the present invention may be composed of one or more sub-components, and some of these sub-components may be omitted or additional sub-components may be included. Some components (modules or programs) may be integrated into a single entity to perform the same or similar functions as those performed by each corresponding component prior to integration. The operations performed by the modules, programs, or other components according to an embodiment of the present invention may be executed sequentially, in parallel, iteratively, or heuristically; at least some of the operations may be executed in a different order, omitted, or supplemented with additional operations.

The foregoing description of the present invention is provided for illustrative purposes, and it will be understood by those skilled in the art that various modifications can be made without departing from the spirit or essential characteristics of the invention. Therefore, the embodiments described above should be understood to be exemplary and non-limiting in all respects. For example, each component described as a single unit may be implemented in a distributed form, and conversely, components described as distributed may also be implemented in an integrated form.

The scope of the present invention is defined by the following claims, and all modifications or variations derived from the meaning, scope, and equivalents of the claims are to be interpreted as being included within the scope of the present invention.

What is claimed is:

1. A method for constructing a graph for approximate nearest neighbor (ANN) search by dynamically adjusting parameters according to data density and dimensional characteristics, the method comprising:
(a) receiving a dataset composed of a plurality of data points represented as multidimensional vectors and initial parameters;
(b) calculating a density of each data point in the received dataset;
(c) determining a range of the parameters in consideration of a variation in the densities;
(d) dynamically adjusting the parameters according to the density of a specific data point based on the determined range of the parameters; and
(e) inserting the specific data point into a graph using the adjusted parameters through a dynamic graph construction step,
wherein the parameters include a ‘maximum number of connections (M_{q})’ and a ‘search depth (ef_{q})’.

2. The method of claim 1,
wherein step (b) comprises projecting the dataset into a lower-dimensional space using a Random Projection (RP) method, and calculating a density for each data point in the lower-dimensional dataset using a K-Nearest Neighbors (KNN) method.

3. The method of claim 1,
further comprising step (f) of setting a reference value (ef_{ref}) for the search depth by considering the number of dimensions of the dataset according to Equation (1).
$$e {f}_{ref} = ⌊ {ef}_{init} + {( \frac{dim ( D )}{α} )}^{2} ⌋ \qquad [ Equation 1 ]$$
Wherein, efᵢₙᵢₜ denotes an initial search depth, dim(D) represents the number of dimensions of the dataset, parameter α indicates an adjustment parameter, and └ ┘ represents a floor operation symbol for rounding down to the nearest integer.

4. The method of claim 3,
wherein step (c) represents the variation in data density using statistical values of data density including an average (ρ_{μ}) and a standard deviation (ρ_{σ}),
determines a lower limit and an upper limit of the ‘maximum number of connections (M_{q})’ through Equations (2) and (3), respectively,
and determines a lower limit and an upper limit of the ‘search depth (ef_{q})’ through Equations (4) and (5), respectively.
$${M}_{l o w} = max ( 2 , ⌊ {M}_{init} - {M}_{init} \times \frac{{ρ}_{σ}}{{ρ}_{μ}} \times λ ⌋ ) \qquad [ Equation 2 ]$$
$${M}_{high} = ⌊ {M}_{init} + {M}_{init} \times \frac{{ρ}_{σ}}{{ρ}_{μ}} \times λ ⌋ \qquad [ Equation 3 ]$$
Wherein, Mᵢₙᵢₜ denotes an initial maximum number of connections set by a user, ρ_{σ} represents the standard deviation of dataset density, ρ_{μ} represents the average density of the dataset,
$$\frac{{ρ}_{σ}}{{ρ}_{μ}}$$
indicates a variation coefficient that represents the variability of density within the dataset, and λ denotes an expansion coefficient that controls the sensitivity of parameter adjustment according to density variation.
$$e {f}_{l o w} = max ( 10 , ⌊ {ef}_{ref} - e {f}_{ref} \times \frac{{ρ}_{σ}}{{ρ}_{μ}} \times λ ⌋ ) \qquad [ Equation 4 ]$$
$$e {f}_{h i g h} = ⌊ {ef}_{ref} + e {f}_{ref} \times \frac{{ρ}_{σ}}{{ρ}_{μ}} \times λ ⌋ \qquad [ Equation 5 ]$$
Wherein, ef_{ref} represents a reference search depth.

5. The method of claim 1,
wherein step (d) dynamically adjusts the ‘maximum number of connections (M_{q})’ according to Equation (6).
$${M}_{q} = ⌊ {M}_{l o w} + ( \frac{{ρ}_{q} - {ρ}_{m i n}}{{ρ}_{ma x} - {ρ}_{m i n}} ) \times ( {M}_{h i g h} - {M}_{l o w} ) ⌋ \qquad [ Equation 6 ]$$
Wherein, M_{low} denotes a lower limit of M_{q}, M_{high} denotes an upper limit of M_{q}, ρₘᵢₙ represents a minimum value of data density, and ρₘₐₓ represents a maximum value of data density.

6. The method of claim 1,
wherein step (d) dynamically adjusts the ‘search depth (ef_{q})’ according to Equation (7).
$$e {f}_{q} = ⌊ {ef}_{l o w} + ( \frac{{ρ}_{q} - {ρ}_{m i n}}{{ρ}_{m ax} - {ρ}_{m i n}} ) \times ( e {f}_{h i g h} - e {f}_{l o w} ) ⌋ \qquad [ Equation 7 ]$$
Wherein, ef_{low} denotes a lower limit of ef_{q}, ef_{high} denotes an upper limit of ef_{q}, ρₘᵢₙ represents a minimum value of data density, and Pmax represents a maximum value of data density.

7. The method of claim 1,
further comprising a step of repeatedly performing steps (d) and (e) for all data points in the dataset.

8. The method of claim 1,
wherein the graph is a Hierarchical Navigable Small World (HNSW) graph.

9. A computer program for constructing a graph for approximate nearest neighbor (ANN) search by dynamically adjusting parameters according to data density and dimensional characteristics,
the computer program comprising instructions that, when executed by a processor of a computer device, cause the processor to:
(a) receive a dataset composed of a plurality of data points represented as multidimensional vectors and initial parameters;
(b) calculate a density of each data point in the received dataset;
(c) determine a range of the parameters in consideration of variations in the densities;
(d) dynamically adjust the parameters according to the density of a specific data point based on the determined range of the parameters; and
(e) insert the specific data point into a graph using the adjusted parameters through a dynamic graph construction step,
wherein the parameters include a ‘maximum number of connections (M_{q})’ and a ‘search depth (ef_{q})’,
the computer program being stored on a computer-readable recording medium.

10. The computer program of claim 9,
wherein step (b) comprises projecting the dataset into a lower-dimensional space using a Random Projection (RP) method, and calculating a density for each data point in the lower-dimensional dataset using a K-Nearest Neighbors (KNN) method,
the computer program being stored on a computer-readable recording medium.

11. The computer program of claim 9,
wherein the graph construction method for approximate nearest neighbor search further comprises:
(f) setting a reference value ef_{ref} for the search depth by considering the number of dimensions of the dataset according to Equation (1),
the computer program being stored on a computer-readable recording medium.
$$e {f}_{ref} = ⌊ {ef}_{init} + {( \frac{dim ( D )}{α} )}^{2} ⌋ \qquad [ Equation 1 ]$$
Wherein, efᵢₙᵢₜ denotes an initial search depth, dim(D) represents the number of dimensions of the dataset, parameter α indicates an adjustment parameter, and └ ┘ represents a floor operation symbol for rounding down to the nearest integer.

12. The computer program of claim 11,
wherein step (c) represents the variation in data density using statistical values of data density including an average (ρ_{μ}) and a standard deviation (ρ_{σ}),
determines a lower limit and an upper limit of the ‘maximum number of connections (M_{q})’ through Equations (2) and (3), respectively,
and determines a lower limit and an upper limit of the ‘search depth (ef_{q})’ through Equations (4) and (5), respectively,
the computer program being stored on a computer-readable recording medium.
$${M}_{l o w} = max ( 2 , ⌊ {M}_{init} - {M}_{init} \times \frac{{ρ}_{σ}}{{ρ}_{μ}} \times λ ⌋ ) \qquad [ Equation 2 ]$$
$${M}_{high} = ⌊ {M}_{init} + {M}_{init} \times \frac{{ρ}_{σ}}{{ρ}_{μ}} \times λ ⌋ \qquad [ Equation 3 ]$$
Wherein, Mᵢₙᵢₜ denotes an initial maximum number of connections set by a user, ρ_{σ} represents the standard deviation of dataset density, ρ_{μ} represents the average density of the dataset,
$$\frac{{ρ}_{σ}}{{ρ}_{μ}}$$
indicates a variation coefficient representing the variability of density within the dataset, and λ denotes an expansion coefficient that controls the sensitivity of parameter adjustment according to density variation.
$$e {f}_{l o w} = max ( 10 , ⌊ {ef}_{ref} - e {f}_{ref} \times \frac{{ρ}_{σ}}{{ρ}_{μ}} \times λ ⌋ ) \qquad [ Equation 4 ]$$
$$e {f}_{h i g h} = ⌊ {ef}_{ref} + e {f}_{ref} \times \frac{{ρ}_{σ}}{{ρ}_{μ}} \times λ ⌋ \qquad [ Equation 5 ]$$
Wherein, ef_{ref} represents a reference search depth.

13. The computer program of claim 9,
wherein step (d) dynamically adjusts the ‘maximum number of connections (M_{q})’ according to Equation (6),
the computer program being stored on a computer-readable recording medium.
$${M}_{q} = ⌊ {M}_{l o w} + ( \frac{{ρ}_{q} - {ρ}_{m i n}}{{ρ}_{ma x} - {ρ}_{m i n}} ) \times ( {M}_{h i g h} - {M}_{l o w} ) ⌋ \qquad [ Equation 6 ]$$
Wherein, M_{low} denotes a lower limit of M_{q}, M_{high} denotes an upper limit of M_{q}, ρₘᵢₙ represents a minimum value of data density, and ρₘₐₓ represents a maximum value of data density.

14. The computer program of claim 9,
wherein step (d) dynamically adjusts the ‘search depth (ef_{q})’ according to Equation (7),
the computer program being stored on a computer-readable recording medium.
$$e {f}_{q} = ⌊ {ef}_{l o w} + ( \frac{{ρ}_{q} - {ρ}_{m i n}}{{ρ}_{m ax} - {ρ}_{m i n}} ) \times ( e {f}_{h i g h} - e {f}_{l o w} ) ⌋ \qquad [ Equation 7 ]$$
Wherein, ef_{low} denotes a lower limit of ef_{q}, ef_{high} denotes an upper limit of ef_{q}, ρₘᵢₙ represents a minimum value of data density, and ρₘₐₓ represents a maximum value of data density.

15. The computer program of claim 9,
wherein the graph construction method for approximate nearest neighbor search further comprises a step of repeatedly performing steps (d) and (e) for all data points in the dataset,
the computer program being stored on a computer-readable recording medium.

16. The computer program of claim 9,
wherein the graph is a Hierarchical Navigable Small World (HNSW) graph,
the computer program being stored on a computer-readable recording medium.

17. A computer-readable recording medium on which the computer program, according to claim 9 is recorded.
